(19) United States
(12) Patent Application Publication
(10) Pub. No.: US 2017/0239726 A1
(43) Pub. Date: Aug. 24, 2017

(54) POROUS DEVICES MADE BY LASER ADDITIVE MANUFACTURING

(71) Applicant: Mott Corporation, Farmington, CT (US)

(72) Inventors: Vincent P. Palumbo, Southington, CT (US); Alfred Romano, Terryville, CT (US); John Lisitano, Middletown, CT (US); James Steele, Rockfall, CT (US); Kenneth L. Rubow, Avon, CT (US); Joseph M. Gabriel, Dover, NH (US)

(21) Appl. No.: 15/395,528

(22) Filed: Dec. 30, 2016

Related U.S. Application Data
(60) Provisional application No. 62/273,118, filed on Dec. 30, 2015.

(51) Int. Cl. B22F 3/11; B33Y 10/00; B01D 39/14; B29C 67/00; B01D 39/20; B01D 39/16; B22F 3/105; B33Y 80/00

(52) U.S. Cl. CPC B22F 3/11; B22F 3/1055; B33Y 10/00; B33Y 80/00; B29C 67/0077; B01D 39/2034; B01D 39/1638; B01D 39/14; B01D 2239/1241; B01D 2239/1216; B01D 2239/10

(57) ABSTRACT

The present invention utilizes laser additive manufacturing technologies (“LAMT”) for the creation of porous media that can be used in filtration devices, flow control devices, drug delivery devices and similar devices that are used for, or in conjunction with, the controlled flow of fluids (e.g., gases and liquids) therethrough.

### RELATED APPLICATIONS

This application claims priority to U.S. Provisional Patent Application Ser. No. 62/273,118, filed on Dec. 30, 2015 and entitled “POROUS DEVICES MADE BY LASER ADDITIVE MANUFACTURING”. The contents of the aforementioned application are incorporated herein by reference.

### TECHNICAL FIELD

Embodiments of the present invention relate generally to methods of making porous devices by laser additive manufacturing, and devices made thereby.

### BACKGROUND

There are numerous applications requiring a porous open cell structures that are used for the filtration and/or flow control of fluids (i.e., gas and/or liquids). These structures may be formed using conventional techniques by compacting metallic or ceramic powder or particles to form a green compact and then sintering to form a coherent porous structure. Particle size, compaction force, sintering time, and sintering temperature may all influence pore size and mechanical properties. Generally, pore size is an important factor in the ability of a sintered structure to filter fluids and control the rate of fluid flow through the sintered structure.

Although conventional sintered metal and ceramic powder products have been successfully manufactured and used for flow control and filtration applications, the porosity and other structural properties of the resultant products, and therefore the performance characteristics, may be limited by the manufacturing process. For example, the structure in such materials may result in a limited flow rate for a given pore size required for predetermined filtration specifications. There is therefore a need for filtration devices, flow control devices, drug delivery devices and similar devices that have novel fluid flow and filtration characteristics. There is also a need to manufacture devices with increasingly complex and novel shapes, devices with integral porous media and solid portions, and media with duplex structures

### BRIEF DESCRIPTION OF THE DRAWINGS

FIG. 1 is a photograph of a porous disc created using conventional sintering manufacturing processes (left) and a porous disc created using LAMT in accordance with an embodiment of the present invention (right).

FIG. 2A is a photograph of a cup assembly that includes LAMT porous media structure fabricated with an outer solid full density structure in accordance with an embodiment of the present invention (right) and a cup assembly consisting of porous metal cup sinter-bonded to a solid metal sleeve using conventional manufacturing techniques (left). FIG. 2B is a photograph of the cup assemblies shown in FIG. 2A from an end perspective.

FIG. 3A is a photograph of LAMT porous media structures fabricated with an outer solid full density structure in accordance with embodiments of the present invention (right two pieces) and a flow restrictor consisting of porous metal plug sinter-bonded to a solid metal sleeve manufactured using conventional sintering techniques (far left). FIG. 3B and FIG. 3C are a light optical micrograph and scanning electron micrograph, respectively, of a LAMT porous media structure manufactured in accordance with an embodiment of the present invention showing the interface between the solid full density portion of the structure and the porous portion of the structure.

FIG. 4 is a scanning electron micrograph of the discs shown in the photograph of FIG. 1.

FIG. 5A is a graph showing the effect of operating parameters on flow performance of 1 inch diameter discs fabricated via LAMT. FIG. 5B is a graph that shows flow performance of 1 inch discs manufactured via LAMT (denoted as “80%” which represents the percentage reduction in default laser power used to manufacture the LAMT disc) and via conventional pressing and sintering (denoted by “Mott MG5”). As described further herein, the LAMT disc results in favorable flow characteristics in which approximately 50% more flow is observed compared to the conventionally produced disc having the same maximum pore size.

FIG. 6 shows a graph of average N₂ flow per unit area at a given pressure drop for restrictor style LAMT parts, in accordance with an embodiment of the present invention.

FIG. 7 includes scanning electron micrographs of a conventionally fabricated cup assembly and a LAMT fabricated cup assembly in accordance with an embodiment of the present invention.

FIG. 8 represents the flow characteristics of the LAMT cup assemblies manufactured in accordance with the present invention (denoted as “LAMT Normalized”) compared to conventional equivalents (denoted as “Mott Normalized”). Similar to the flow characteristics observed in FIG. 5B, the LAMT cups have approximately 50% more flow per unit area compared to cups manufactured using conventional sintering techniques while exhibiting approximately the same maximum pore size.

FIG. 9 is drawing of a bellows style filter assembly that may be manufactured using LAMT techniques of the present invention.

FIG. 10 is a photograph of an extended area pack including porous cups that may be manufactured using LAMT techniques of the present invention.

FIG. 11 is a photograph of a spherical porous structure, sinter bonded to a metal tube, which is an example of a product used for NASA Flame propagation device that may be manufactured using LAMT techniques of the present invention.

FIG. 12 is a photograph of a cone shaped porous structure with uniform wall thickness that may be manufactured using LAMT techniques of the present invention.

FIG. 13 is a schematic illustration of a layered porous structure consisting of a coarse substrate and a fine membrane layer on its surface.

FIG. 14 is a histogram chart showing the pore size distribution in micrometers for a part manufactured using LAMT techniques in accordance with an embodiment of the present invention.

FIG. 15 is a drawing of a conventionally pressed and sintered disc with a solid ring printed around its periphery, in accordance with an embodiment of the present invention.

FIG. 16 is an assembly containing ¼″ male NPT hardware (on left) that is sinter-bonded to a conventionally pressed and sintered porous cup representing a standard Mott 316L stainless steel Media Grade 5 media cup (on right), which porous component could be fabricated in accordance with LAMT embodiments of the present invention.

### DETAILED DESCRIPTION OF THE PREFERRED EMBODIMENTS

The present invention utilizes laser additive manufacturing technology (“LAMT”) for the creation of porous media that can be used in filtration devices, flow control devices, drug delivery devices and similar devices that are used for, or in conjunction with, the controlled flow of fluids (e.g., gases and liquids) there through. As used herein, additive manufacturing refers to a 3D printing process whereby successive layers of material are formed to create an object of a desired shape. Laser additive manufacturing refers to additive manufacturing techniques that employ a laser to melt, soften, sinter or otherwise affect the material used in the object being manufactured. By varying material and manufacturing process specifications and conditions, a desired and tailored pore size, morphology and distribution can be produced. The resultant porous structure may be used as is, or it may be joined or otherwise fabricated with a solid full density component to complete a finished product. As used herein, “solid” and “substantially non-porous” are used synonymously to mean a component does not exhibit a through-thickness interconnected porosity. The laser additive manufacturing processes of the present invention are used to create porous structures, solid structures, and structures that have both porous and solid portions that are integrally formed together.

Generally, the laser additive manufacturing processes described herein, when used in accordance with the present invention, are used to create unique porous structures that result in lower pressure drop properties (as described herein) for a given pore size when compared with conventional powder compacted/sintered porous structures. The manufacturing processes of the present invention offer the additional abilities to create finished form parts in customized materials and geometries, and to vary the pore structure within a product for customized and unique properties. The porous media of the present invention that are produced from LAMT techniques are long lasting and provide efficient particle capture, flow restrictor-control, wicking, and gas/liquid contacting. The LAMT processes of the present invention utilize a unique, controlled powder particle recipe (spherical and/or irregular shaped powder) that serves as the feed material for the products to be manufactured. The particles can be joined through the use of laser technology to form an interconnected pore structure that provides uniformly sized predicted sintered pores. The various pores size that can be produced for specific applications can be grouped or classified in media or product grades of 0.1 to 200 micrometers, which represents average pore sizes of the manufactured products.

The type of laser additive manufacturing used in the present invention is any applicable technique, such as selective laser melting, selective laser sintering, and direct metal laser sintering. As is known in the art, selective laser melting results in the complete or near-complete melting of particles using a high-energy laser; whereas selective laser sintering and direct metal laser sintering results in the sintering of particulate material, binding the material together to form a structure. Generally, in accordance with embodiments of the present invention, laser additive manufacturing techniques that result in the sintering of particles are preferred over those that result in the melting of particles because melting techniques can result in a less porous structure than those preferred for use in the present invention. The lasers used in the present invention include any suitable lasers, such as carbon dioxide pulsed. As known in the art, the laser scans across the surface of a first layer of a particle bed placed onto a build plate (i.e., an underlying support structure of any suitable size, shape and composition) to melt or sinter the particles, followed by the application of another layer of particles for subsequent laser scanning and melting or sintering. Multiple subsequent layers are created as the laser scans across the bed and layers of particulate are applied as necessary to create a product with a desired size and shape, often in accordance with CAD data corresponding to a 3D description of the product. The product is optionally separated from the build plate to form a final product suitable for use, unless the build plate is intended to be an integral component of the final product. As used herein, “sinter” refers to any process in which particles are joined together by heat without the complete melting of the particles.

Along with processing parameters such as laser power and raster speed, and particle size, shape, roughness and composition, the inventors have found that the build angle (i.e., the angle at which the LAMT product is formed relative to the horizontal plane of the build plate) is meaningful for the production of the products of the present invention. Specifically, the inventors have found that building layers of particulate material using LAMT techniques to form structures at no less than 30° relative to the build plate is sufficient to prevent deterioration within the LAMT structure. Exemplary embodiments of the present invention form LAMT structures at 30°, 45°, and 60° relative to the build plate. Forming the LAMT product at a build angle, in contrast to forming the LAMT product at no build angle such that it is in contact with the build plate at all locations along its cross-section, has the advantageous result of reducing the portion of the LAMT manufactured product that remains in contact with (and possibly bonded to) the build plate after completion of the LAMT process. LAMT products that are printed at a build angle may therefore be easier to separate from underlying build plates, in the event that such separation is desired. Build angles less than 30°, however, generally may not result in enough of a basis for subsequent layer deposition. With insufficient support from base layer(s) that may result from build angles less than 30°, the resulting porous components may lose product integrity across multiple build layers.

The materials used in the present invention are any materials provided in particulate form that can be sintered, partially melted, or entirely melted by a laser used in laser additive manufacturing techniques. As used herein, “particulate,” “particles,” and “powder” are used synonymously to mean particles that are sized on the order of millimeters, micrometers or nanometers, and have any suitable shape such as spherical, substantially spherical (e.g., having an aspect ratio greater than 0.6, 0.7 or 0.8) and irregular, and mixtures thereof. A preferred particle size range for use in the present invention is less than 10 to 500 micrometers. The particle surface edge(s) may be smooth, sharp, or a mixture thereof. Preferred materials for use in the present invention include materials such as, for example, nickel, cobalt, iron, copper, aluminum, palladium, titanium, tungsten, platinum, silver, gold, and alloys and oxides thereof including stainless steels and nickel-based steels such as Hastelloy® (Haynes Stellite Company, Kokomo, Ind.). Various polymer materials may also be used.

The products made by the present invention, or that incorporate components made by the present invention, include but are not limited to discs, cups, bushings, sheet, tubes, rods, sleeved porous assemblies, cup assemblies, cones, flow restrictors and filtration devices.

In accordance with certain embodiments of the present invention, finished form filter and flow control devices are fully processed using LAMT technologies, which can be used to provide a smooth transition from the porous structure portion of the finished device to a full dense (solid, substantially non-porous) surrounding structure portion of the device. The elimination of joints between porous and solid product portions, which results from the joining of multiple product components required by conventional manufacturing techniques, is one of the advantages of the present invention because of the reduced risk of leaks and the elimination of the requirements for joining and integrating techniques. The use of LAMT techniques in accordance with certain embodiments of the present invention allows for the manufacturing of products that have porous media portions and solid structure all within one manufacturing cycle. Such products are suitable for myriad industrial applications, such as, for example, simple sieving and depth filtration applications, stripping oxygen from fluids, as bubblers, as flame arrestors in critical sensor protection, gas and liquid flow restrictors, diffusers and sound snubbers.

Pore size and distribution are important factors to consider when selecting media grade for filtration and fluid flow restrictor devices, in particular. Pore size controls the pressure drop, the level of particle filtration, the location where the particles are deposition either on or within the porous structure, the bubble size for sparging, fluid wicking, fluid diffusion, etc. Therefore, the ability to fabricate a predetermined pore size and form of the interconnected pores in a consistent, controllable and reproducible manner is a significant advantage offered by the LAMT techniques of the present invention. Moreover, the LAMT techniques of the present invention allow for the ability to design and manufacture components with unique and variable density distributions that are achieved by precisely controlling the size, structure and distribution of the pores throughout such components. Components of the present invention can therefore be characterized by densities that are substantially uniform throughout, that vary at a constant rate, or that vary at variable rates.

In some embodiments, a “media grade” is defined to describe some of the properties of the porous products made via LAMT. The media grade may, for example, indicate the nominal mean flow pore size of the product and may be calculated using a standard industry bubble-point test as defined by, for example, ISO 4003 or ASTM E128. For example, a media grade 1 product is characterized by a nominal mean flow pore size of one micron, and a media grade 2 product is characterized by a nominal mean flow pore size of two microns. The media grade may not, however, correspond to an exact pore size; the products of the present invention may define pores having a wide distribution of sizes.

When used in devices that deliver controlled quantities of liquid drugs over time, the interconnected porous structures created through the LAMT techniques of the present invention provide flow paths that can be tailored to specific drug diffusion rates. The porous media created through this technology is similar in nature to the filter and flow control media in the ability to control pore size through powder recipe and machine parameters. The drug or other materials pass through controlled pore size and varying levels of tortuosity. The delivery of the various forms of drug molecules through the device is controlled by diffusion across a barrier medium, i.e., the porous sintered metal that is produced. The ability to produce different size pores and layers can vary and control the rate of diffusion is significant and unique to the controls that can be built into the media and overall finished form device. Through the ability to vary materials, pore size, thickness, and area of the component the rate of drug diffusion can be tuned into what is desired. These determined adjustments will enable a small implant the ability to provide passive long term, constant-rate drug delivery.

### EXAMPLES

The present invention is further described with reference to the following non-limiting examples.

### Example 1—Examples of Disc, Cup Assembly and Restrictor Made with LAMT Compared to Parts Made with Conventional Manufacturing Techniques

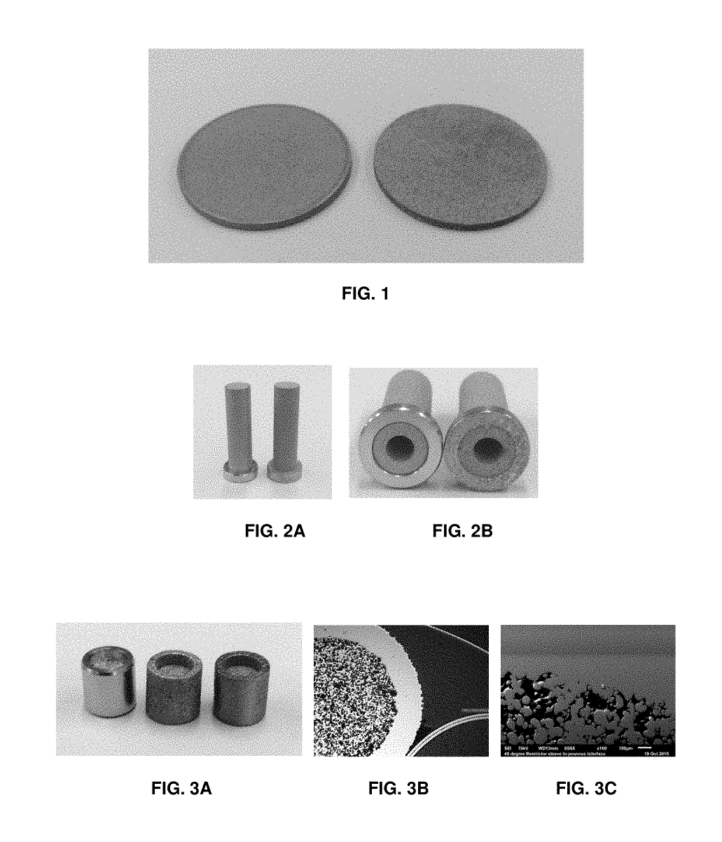

FIG. 1 is an image of a conventionally pressed and sintered disc (left) and a LAMT printed disc (right). Both discs were fabricated from 316L stainless steel particles. The conventional discs were made from irregularly shaped powder particles, and the LAMT discs were fabricated from powder particles that were spherically shaped with an average particle of 39 micrometers and having the physical characteristics set forth in Table I (apparent density and particle size distribution):

TABLE I
Apparent Density and Particle Characteristics
used for LAMT Fabrication

| Apparent Density (g/cc) 4.0512 | | | |
|---|---|---|---|
| | Sieve | | |
| Sieve | Opening | Weight | |
| Mesh | (micrometers) | (g) | Percent |
| 230 | 63 | 0.06 | 0.200 |
| 270 | 53 | 1.67 | 5.580 |
| 325 | 44 | 3.75 | 12.53 |
| 400 | 37 | 5.98 | 19.98 |
| 500 | 25 | 12.87 | 43.00 |
| 635 | 20 | 3.84 | 12.83 |
| −635 | <20 | 1.76 | 5.880 |
| | Total | 29.93 | 100 |

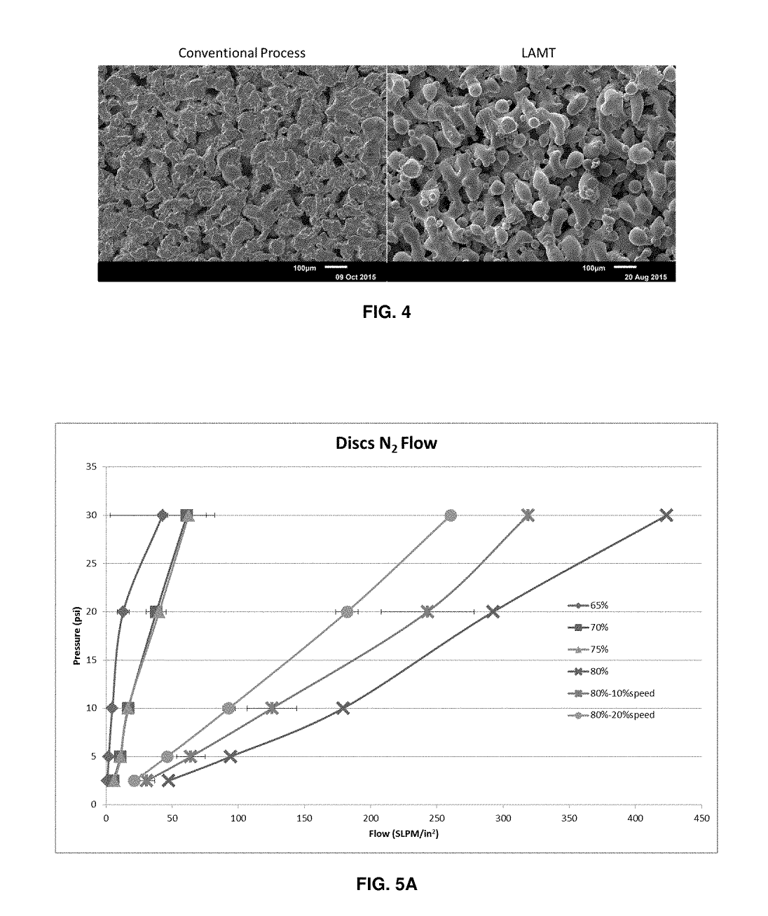

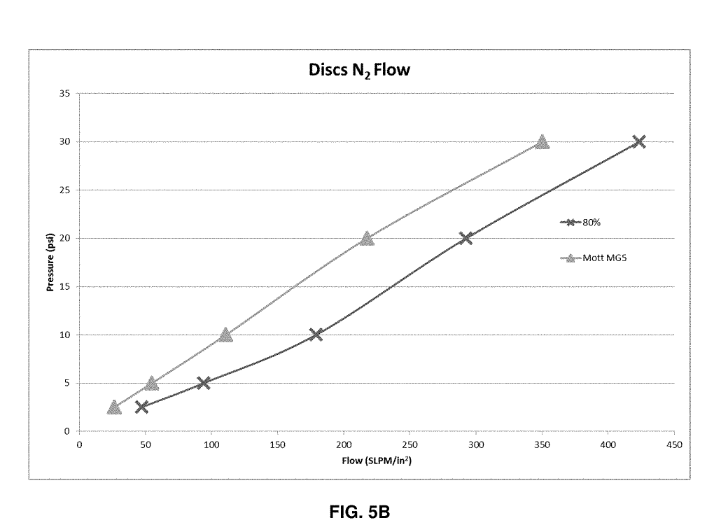

FIG. 4 shows scanning electron micrographs of the surfaces of these manufactured discs, illustrating the differences in the structures resulting from conventional and LAMT manufacturing techniques. The individual powder particle morphologies differ due to the conventional process utilizing irregularly shaped powder particles, while the LAMT process uses spherical powders. The different structures result in meaningful performance differences. For example, the flow of gaseous nitrogen through a disc that was manufactured using conventional sintering and pressing techniques (and thus having a structure corresponding to the “Conventional Process” photomicrograph shown in FIG. 4) was compared to an identically sized disc manufactured during LAMT. The measured bubble point of the conventionally manufactured and LAMT discs were 1.17″ Hg and 1.13″ Hg, respectively, thus evidencing the similar maximum pore sizes between the two samples. As shown in FIG. 5B, however, the pressure required for a given flow rate of nitrogen through each disc was significantly lower for the LAMT disc than for the conventionally manufactured disc. Said another way, a significantly higher flow rate was observed for the LAMT disc for a given pressure. Without wishing to be bound by theory, the inventors have observed that conventionally prepared parts can exhibit density gradients resulting from the process of mechanical pressing, and these density gradients can adversely impact fluid flow. Conversely, LAMT parts are generally homogeneous in structure and do not exhibit density gradients and any resultant adverse impact upon fluid flow. The homogeneous 3-dimensional porous structures resulting from LAMT techniques of the present invention generally consist of a uniform distribution of interconnected pores between fused powder particles.

FIG. 5A shows the pressure-flow curves for the flow of gaseous nitrogen through LAMT discs, and illustrates the versatility of LAMT techniques. Each curve shows pressure as a function of flow for six different discs, each manufactured according to LAMT processing parameters shown in the figure. The percentages listed in FIG. 5A represent the percent decrease in the default laser power, or the percent decrease in the default laser speed where indicated. As can be seen from inspection of FIG. 5A, decreases in laser power result in a higher flow rate for a given pressure, which is expected from a larger pore size resulting from less particle sintering and/or melting. Conversely, decreases in laser speed result in a lower flow rate for a given pressure, which is expected from a smaller pore size resulting from greater particle sintering and/or melting.

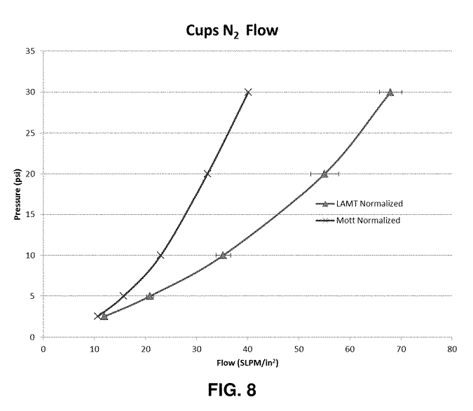

FIGS. 2A and 2B show images of dual density (porous/fully dense) structures making up a cup assembly. A conventionally fabricated assembly is shown on the left-hand side of each image. The solid ring at the base of each assembly is machined separately from the pressed and sintered cup portion of each assembly. The cups are pressed into the rings and attached via sinter-bonding. The cup assembly on the right-hand side of each image was fabricated via LAMT in one build using the stainless steel particles described for the discs shown in FIG. 1, without the need to separately manufacture and attach a solid ring. Note that while the product shown in the right-hand side of each photograph is referred to as a “cup assembly,” it is actually an integral part rather than an assembly of multiple components. Custom parameter settings allow for the transition from printing a solid structure to a controlled porous structure without interruption of the building process. FIG. 7 includes scanning electron micrographs of the conventionally fabricated and LAMT fabricated cup assemblies. The left hand set of images is taken approximately parallel to the long axis of the cups while the right hand set of images is perpendicular. Similar to what is observed in FIG. 4 for discs produced by conventional processes versus LAMT, while the individual particle morphologies differ, the overall morphologies, including the pore structures, are comparable. FIG. 8 represents the flow characteristics of the LAMT cup assemblies (denoted as “LAMT Normalized”) compared to conventional equivalents (denoted as “Mott Normalized”). The pressure drops of the LAMT cups are significantly lower than that of the conventionally processed cup assembly, which translates to increased flow per unit area with similar filtration capability. The data also shows good repeatability in LAMT cup assemblies (sample size of 10 parts) with standard deviations in overall length of ±0.002″, ±0.0005″ in outer diameter (OD), inner diameter (ID) and solid ring OD as well as ±0.001″ in solid ring thickness. Bubble points between cups averaged 0.6″ Hg±0.18.

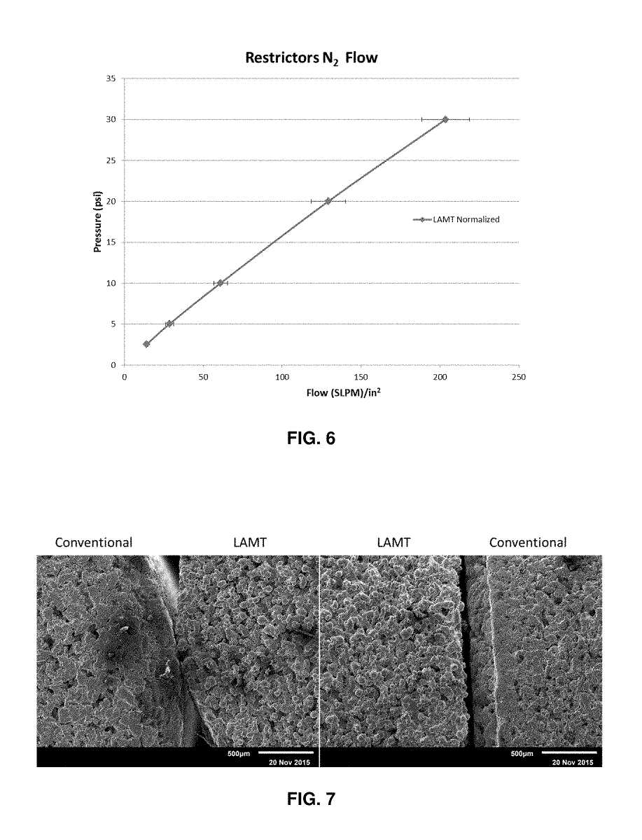

FIGS. 3A-3C show images of fluid flow restrictor type products that include a porous restrictor component within a solid sleeve. The product on the far left side of FIG. 3A is fabricated via conventional processes including pressing and sintering of a porous insert, machining of a solid outer sleeve, pressing the insert into the outer sleeve, and sinter-bonding and tuning the components into a unitary product. The flow restrictor products shown in the center and right side of FIG. 3A are made via LAMT in one build, without the need to separately manufacture an outer sleeve. In other words, the laser additive manufacturing process is used to manufacture both the porous restrictor component within a solid sleeve in a single manufacturing process without the need to separately manufacture different components and assemble them together. FIG. 3B shows the cross-section of a restrictor product manufactured by LAMT showing the transition from the fully dense outer sleeve to the porous material within. FIG. 3C is a scanning electron photomicrograph showing the interface between the porous restrictor portion and the solid sleeve portion of the product made by LAMT. FIG. 6 shows a plot of average N₂ flow per unit area at a given pressure drop for the restrictor style LAMT parts. Good repeatability between parts was observed (sample size of 10) having standard deviations of approximately 7%.

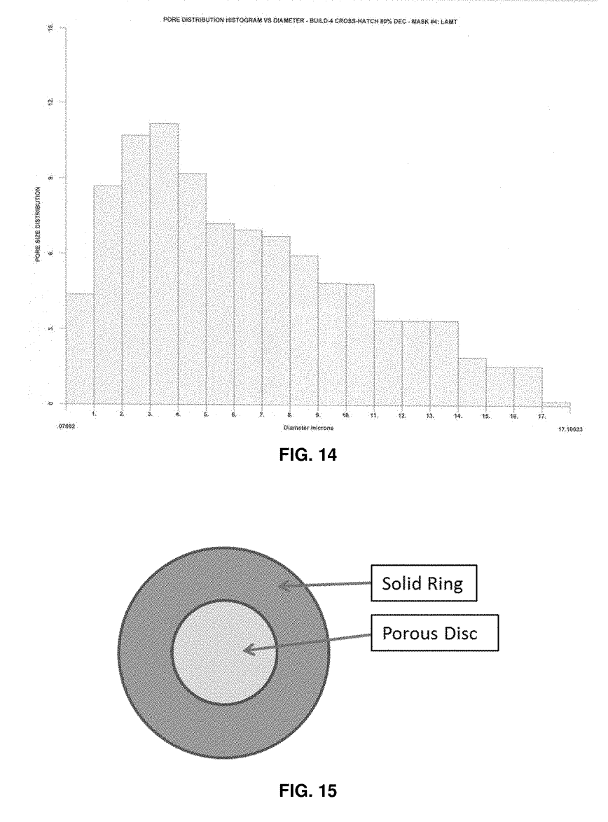

The chart in FIG. 14 provides an example of the pore size distribution that can be produced using LAMT techniques in accordance with embodiments of the present invention. This distribution can be further optimized and controlled through adjusting manufacturing parameters such as laser power, laser raster speed (i.e., the speed at which a laser beam is moved across the particles, or the speed at which a particle bed is otherwise moved relative to a laser beam), particle size and composition. For example, higher laser powers and slower raster speeds can generally result in a more dense, less porous structure than lower laser powers and faster raster speeds, for a given particle size, shape and composition.

### Example 2—Novel Shapes for Filters, Flow Control Devices and Other Devices Fabricated Using LAMT Technologies

The present invention includes porous parts of various geometries, with or without integrated solid hardware, designed for enhanced performance. For example, in comparison to devices formed by conventional sintering techniques, the filter and flow control devices formed in accordance with the present invention result in an increase in the filter or flow control surface area without increasing the overall dimensions of the finished product. In other words, devices that are manufactured in accordance with the present invention are preferably manufactured with reduced product dimensions, but equivalent or superior functional performance, when compared with conventional sintered products.

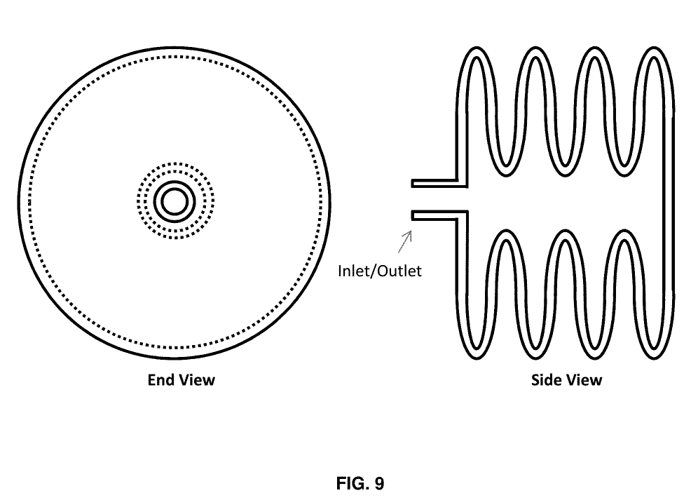

FIG. 9 shows end and side views of a bellows style filter assembly manufactured utilizing the LAMT techniques of the present invention. The inlet/outlet region is solid material to enable interfacing it to other hardware while the entire remaining portion of the part is a porous structure. This entire part, including both the solid inlet/outlet region and the porous, bellows-design filtration element is completely manufactured using LAMT in a single process. This novel design provides increased filtration surface area in comparison to filtration designs that may be manufactured using conventional means, such as a cylindrical shape. In the scale shown here, the surface area of the assembly shown in FIG. 9 is approximately 250% of the surface area of a similarly-sized cylindrical filtration device manufactured by conventional sintering techniques. Moreover, the surface area can be further increased without increasing the overall size of the assembly by simply adding more rings to the bellows design, with smaller spacing between them.

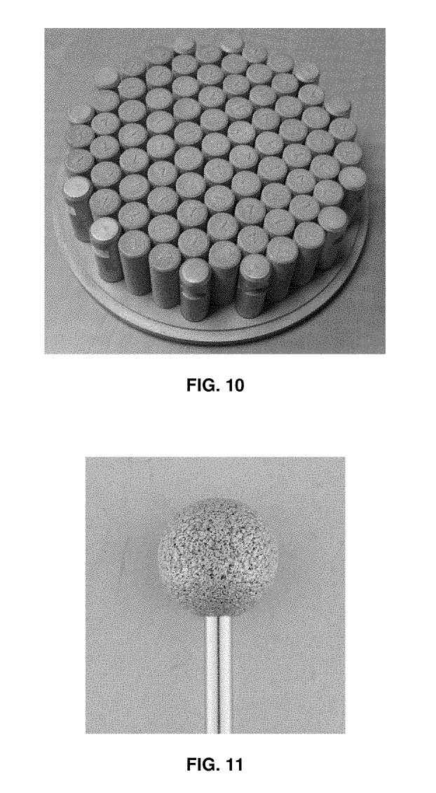

FIG. 10 is a photograph of a multi-cup disc assembly that has been pressed and sinter bonded using conventional sintering techniques. This assembly, and similar assemblies, can be used for a variety of applications including sparging, filtration, and extrusion of polymers. Products like this can easily be fabricated utilizing LAMT techniques to produce the assembly with the high surface area of porous bonded to a solid plate for attachment to its intended application.

FIG. 11 is a photograph of a porous sphere attached to a solid tube used for a flame propagation studies in near zero gravity. Spheres can be printed utilizing LAMT techniques with or without internal cavities giving the capability to produce any desired wall thickness. The solid tube can be inserted and bonded to the sphere as a secondary operation or printed as a solid component during the initial LAMT fabrication.

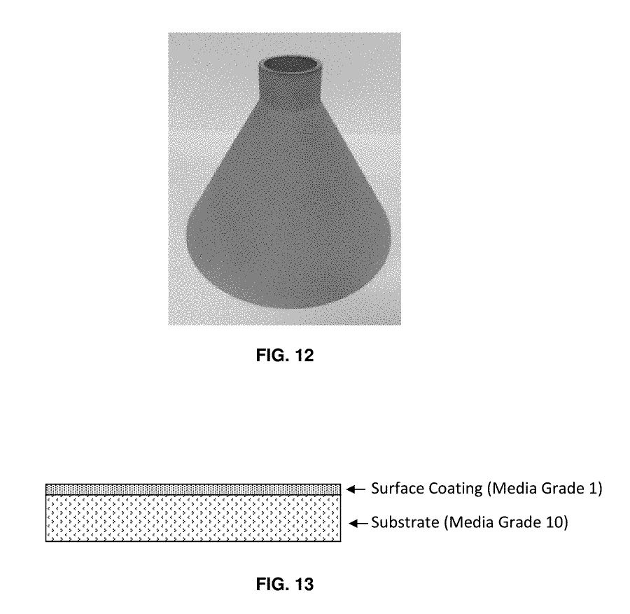

FIG. 12 is a cone shaped porous part made from 316L stainless steel. LAMT techniques can print geometries such as this with virtually any angles for the cone and either consistent or varying wall thickness.

FIG. 13 is an example of a layered structured filter device comprising a substrate printed to produce a coarse pore size to maximum flow (lowest pressure drop) and a thin layer on the substrate with much smaller pores to provide the desired level of filtration efficiency. The coarse substrate gives the filter its required mechanical strength and supports the fine surface or membrane filter layer. The surface membrane layer is thin enough to not create a large pressure drop and results in a filter that can separate very fine particulate without a high pressure drop penalty. Layered structures may also be used for other applications such as restrictors and flow control devices.

The LAMT methods of the present invention may be used for the fabrication of “hybrid assemblies,” which as used herein refers to assemblies comprising at least one portion formed by LAMT techniques, bonded or otherwise joined to at least one portion formed by conventional pressing and sintering techniques. Such hybrid assemblies may be formed, for example, by printing the LAMT portion directly onto the pre-formed conventionally manufactured portion, or by forming each portion separately and bonding them together using heat, pressure and/or mechanical or chemical joining. Each of the LAMT portion and the conventionally manufactured portion may be fully solid or porous. The LAMT and conventionally formed portions of such assemblies may be comprised of any combination of suitable materials for the specific application, including but not limited to nickel, cobalt, iron, copper, aluminum, palladium, titanium, tungsten, platinum, silver, gold, and their alloys and oxides including stainless steel and nickel-based steels such as Hastelloy®. Various polymeric materials may also be used. Such hybrid assemblies, as well as just the porous media, may be used in a variety of applications including but not limited to sound reduction, sparging applications, and filtration and flow control of gases and liquids, gas diffusers, thermal management—heat transfer control, low flow drug delivery, flame arrestors, fluid mixer for such application as chromatography, food and beverage, porous substrate for reactive layer used in fuel cells and hydrogen generation, wicks, porous casting molds, air floatation for material handling, vacuum chucks, porous structures comprised of uniform holes, unique support structures, porous jewelry, action figures, and implantable devices including surgical markers.

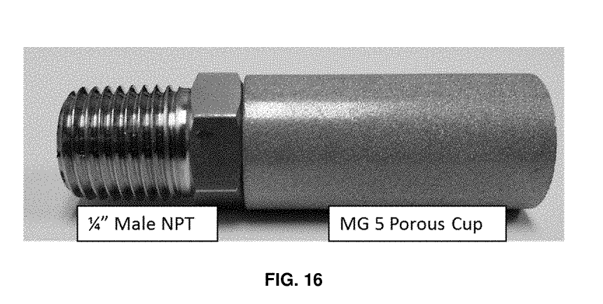

In accordance with an embodiment of the present invention, one example of a hybrid assembly is a device formed by forming a porous disc by conventional techniques (i.e., pressing and sintering metallic particles), followed by printing a sold ring around the circumference of the disc with LAMT techniques to form a structure shown in FIG. 15. Another example of a hybrid assembly, in accordance with an embodiment of the present invention, is shown in FIG. 16, which is a photograph of a 316 stainless steel threaded fitting with a conventionally pressed and sintered porous cup representing a standard Mott 316L stainless steel Media Grade 5 media cup (on right) (Mott Corporation, Farmington, Conn.). The porous component could be fabricated in accordance with embodiments of the LAMT procedures of the present invention. In this example, the hybrid assembly may be used in numerous applications such as a snubber to reduce exhaust noise in a pneumatic valve actuator, or as compression tube fittings, threaded pipe fittings, VCR (vacuum coupling radiation) compression fittings, sanitary and vacuum fittings, and the like.

### Example 3—Comparison of Discs and Fluid Flow Restrictors Including a Porous Restrictor Component within a Solid Sleeve, Fabricated by Conventional Pressing and LAMT

Porous discs such as those shown in FIG. 1, and fluid flow restrictors that include a porous restrictor within a solid sleeve such as those shown in FIG. 3, were manufactured using both conventional sintering manufacturing processes or LAMT. Table II displays performance data for conventionally fabricated 316L stainless steel porous metal parts (designated as “Conventional Pressed Parts”) compared to LAMT parts (designated as “3D Printed (LAMT) Parts”) for given media grade values. The bubble point values are presented in units of ″H₂O and collected in accordance with ASTM E128-99. Each set of columns refers to a relative Particle Size Distribution (PSD) of the metal particles used during the LAMT process. The standard PSD data can be found in Table I and is representative of the powder typically used in metal additive manufacturing equipment. Part permeability was characterized via flow of N₂ at 2.5 psi and is represented in units of Standard Liters Per Minute per Inches Squared (SLM/in²). The permeability data of the conventional pressed parts is normalized to the thicknesses of the comparable LAMT parts tested. Bubble point and flow data are further categorized by internal Mott Media Grade designations ranging from 0.1 up to 100.

TABLE II
Comparison of bubble point values and permeability for discs and fluid flow restrictors including a porous restrictor
component within a solid sleeve, fabricated by conventional pressing and LAMT

| | | | | | 3D Printed (LAMT) Parts | | | | | |
|---|---|---|---|---|---|---|---|---|---|---|
| | Conventional Pressed Parts | | | | Fine PSD | | Std. PSD | | Medium PSD | |
| Mott | Bubble | Std | N2 Flow | | Bubble | N2 Flow | Bubble | N2 Flow | Bubble | N2 Flow |
| Media | Point | Thickness | @ 2.5 psi | | Point | @ 2.5 psi | Point | @ 2.5 psi | Point | @ 2.5 psi |
| Grade | (″H₂O) | (inches) | (SLM/in²) | Part Type | (″H₂O) | (SLM/in²) | (″H₂O) | (SLM/in²) | (″H₂O) | (SLM/in²) |
| 0.1 | 95-122 | 0.137 | 0.18 | Solid/Porous | 111.84 | 0.394 | | | | |
| 0.2 | 68-94 | 0.062 | 0.83 | Disc | | | | | | |
| 0.5 | 40.8-53 | 0.062 | 2.13 | Disc | | | | | | |
| 1 | 27.1-34 | 0.052 | 5.21 | Disc | | | 28.3 | 0.43 | | |
| 1 | 27.1-34 | 0.044 | 6.16 | Disc | 33.74 | 0.203 | | | | |
| 1 | 27.1-34 | 0.137 | 1.98 | Solid/Porous | | | | | 26.95 | 0.705 |
| 2 | 17-24 | 0.052 | 10.68 | Disc | | | 18.44 | 19.46 | | |
| 2 | 17-24 | 0.044 | 12.62 | Disc | 21.67 | 6.26 | | | | |
| 2 | 17-24 | 0.137 | 4.1 | Solid/Porous | | | | | 19.87 | 6.26 |
| 5 | 13-16.9 | 0.044 | 32.6 | Disc | | | 14.41 | 30.94 | | |
| 5 | 13-16.9 | 0.137 | 10.5 | Solid/Porous | 13.17 | 21.19 | | | | |
| 7 | 11-12.9 | 0.044 | 46.2 | Disc | | | 12.23 | 47.29 | 12.33 | 43.57 |
| 10 | 7.5-10.9 | 0.058 | 50.7 | Disc | | | 8.05 | 80.2 | | |
| 10 | 7.5-10.5 | 0.044 | 66.8 | Disc | 9.19 | 74.85 | | | 9.29 | 61.66 |
| 15 | 6-8 | 0.148 | 30.2 | Disc | | | 7.77 | 71.81 | | |
| 20 | 5-7 | 0.0833 | 72.3 | Disc | | | 5.41 | 57.46 | | |
| 20 | 5-7 | 0.042 | 143.3 | Disc | | | | | | |
| 40 | 3-4 | 0.148 | 83.3 | Disc | | | 4.04 | 83.74 | | |
| 60 | 2-2.9 | 0.109 | 172.2 | Disc | | | | | | |
| 80 | 1.2-2.2 | 0.062 | 407.7 | Disc | | | | | | |
| 100 | 0.5-1.5 | 0.062 | 513.6 | Disc | | | | | | |
| | | | | | 3D Printed (LAMT) Parts | | | | | |
| | | | | | | | Very | | Extremely | |
| | Conventional Pressed Parts | | | | Coarse PSD | | Coarse PSD | | Coarse PSD | |
| Mott | Bubble | Std | N2 Flow | | Bubble | N2 Flow | Bubble | N2 Flow | Bubble | N2 Flow |
| Media | Point | Thickness | @ 2.5 psi | | Point | @ 2.5 psi | Point | @ 2.5 psi | Point | @ 2.5 psi |
| Grade | (″H₂O) | (inches) | (SLM/in²) | Part Type | (″H₂O) | (SLM/in²) | (″H₂O) | (SLM/in²) | (″H₂O) | (SLM/in²) |
| 0.1 | 95-122 | 0.137 | 0.18 | Solid/Porous | | | | | | |
| 0.2 | 68-94 | 0.062 | 0.83 | Disc | | | | | | |
| 0.5 | 40.8-53 | 0.062 | 2.13 | Disc | | | | | | |
| 1 | 27.1-34 | 0.052 | 5.21 | Disc | | | | | | |
| 1 | 27.1-34 | 0.044 | 6.16 | Disc | | | | | | |
| 1 | 27.1-34 | 0.137 | 1.98 | Solid/Porous | | | | | | |
| 2 | 17-24 | 0.052 | 10.68 | Disc | | | | | | |
| 2 | 17-24 | 0.044 | 12.62 | Disc | | | | | | |
| 2 | 17-24 | 0.137 | 4.1 | Solid/Porous | | | | | | |
| 5 | 13-16.9 | 0.044 | 32.6 | Disc | | | | | | |
| 5 | 13-16.9 | 0.137 | 10.5 | Solid/Porous | 13.55 | 9.03 | | | | |
| 7 | 11-12.9 | 0.044 | 46.2 | Disc | 11 | 28.51 | | | | |
| 10 | 7.5-10.9 | 0.058 | 50.7 | Disc | | | | | | |
| 10 | 7.5-10.5 | 0.044 | 66.8 | Disc | 10.74 | 74.34 | | | | |
| 15 | 6-8 | 0.148 | 30.2 | Disc | | | | | | |
| 20 | 5-7 | 0.0833 | 72.3 | Disc | | | | | | |
| 20 | 5-7 | 0.042 | 143.3 | Disc | | | 6.28 | 159.42 | | |
| 40 | 3-4 | 0.148 | 83.3 | Disc | | | | | | |
| 60 | 2-2.9 | 0.109 | 172.2 | Disc | | | | | 2.6 | 87.7 |
| 80 | 1.2-2.2 | 0.062 | 407.7 | Disc | | | | | | |
| 100 | 0.5-1.5 | 0.062 | 513.6 | Disc | | | | | | |

Table II highlights the effectiveness of LAMT parameter adjustments and PSD ranges in creating parts that perform similarly and in some cases superior to conventionally pressed parts. These LAMT parts result from a design of experiments study that demonstrated the ability to produce porous metal media, with controlled pore sizes, in a repeatable manner using spherical powder. Of the LAMT products fabricated and tested to generate the data shown in Table II, 68% of such parts had flows that matched, or were superior to, the flow performance of conventional parts with the same Media Grades, while 32% of such parts underperformed the conventionally fabricated parts. In a majority of cases, the superior performing parts had roughly twice the flow of the conventional counterparts. The flow performance advantage is further highlighted in FIG. 8 where permeability data is captured for LAMT and conventionally pressed parts over a range of inlet pressures. This figure shows a nearly two fold increase in flow of LAMT parts versus conventionally pressed parts of equivalent bubble point values. Because the flow versus pressure curves display a non-linear behavior, it is likely that a transition from laminar to turbulent flow is occurring. It is also noted that this transition occurs at a later point with the LAMT parts.

Table II illustrates the high degree of flexibility that can be achieved in creating a variety of porous structures. Within the standard powder PSD, through the use of adjusted LAMT parameters, a wide range of conventionally pressed products can be replicated. The ability to create a varied range of porous media within one PSD of powder lends the ability to generate hierarchical or multiple density type porous components within one build cycle. The cross-section of the part presented in FIG. 13 illustrates the concept of a hierarchical porous component.

In one specific embodiment reported in Table II, a fine PSD part was printed using LAMT techniques as a fluid flow restrictor including a porous restrictor component within a solid sleeve, characterized by a 0.25″ diameter solid sleeve encapsulating a 0.169″ diameter porous disc. This part is equivalent to a standard restrictor assembly as shown in FIG. 3A, with the thickness of the porous media being 0.137″. As can be seen from inspection of Table II, flow data for this part, as measured with N₂ gas at 2.5 psi, was 0.394 SLM/in², and the part had a bubble point of 111.84 ″H₂O (0.1 MG). A comparable part fabricated using conventional sintering techniques, characterized by a comparable thickness porous disc, was measured to have a flow rate of 0.18 SLM/in². As such, the LAMT part was found to have a 119% increase in flow at the same pressure drop compared to conventionally pressed porous media of Mott Media Grade 0.1.

In another specific embodiment reported in Table II, a standard PSD part was printed using LAMT techniques as a porous disc characterized by a diameter of 1.0082″ and a thickness of 0.052″. The bubble point of the disc was measured to be 18.44″ H₂O (equivalent to Mott Media Grade 2) and flowed N₂ gas at a rate of 19.46 SLM/in² at a pressure drop of 2.5 psi. A comparable disc fabricated using conventional sintering techniques flowed at 10.7 SLM/in². As such, the LAMT part was found to have an 82% increase in flow at the same pressure drop compared to conventionally pressed porous media of Mott Media Grade 2.

In another specific embodiment reported in Table II, a standard PSD part was printed using LAMT techniques as a porous disc characterized by a diameter of 0.995″ and a thickness of 0.043″. The bubble point of the disc was measured to be 10.74″ H₂O (equivalent to Mott Media Grade 10) and flowed N₂ gas at a rate of 74.34 SLM/in² at a pressure drop of 2.5 psi. A comparable disc fabricated using conventional sintering techniques flowed at 66.8 SLM/in². As such, the LAMT part was found to have an 11% increase in flow at the same pressure drop compared to conventionally pressed porous media of Mott Media Grade 10.

In yet another specific embodiment reported in Table II, a standard PSD Part was printed using LAMT techniques as a porous disc characterized by a diameter of 0.997″ and a thickness of 0.042″. The bubble point of the disc was measured to be 6.28″ H₂O (equivalent to Mott Media Grade 20) and flowed N₂ gas at a rate of 159.42 SLM/in² at a pressure drop of 2.5 psi. A comparable disc fabricated using conventional sintering techniques flow N₂ gas at a rate of 143.3 SLM/in² at a pressure drop of 2.5 psi. As such, the LAMT part was found to have an 11% increase in flow at the same pressure drop compared to conventionally pressed porous media of Mott Media Grade 20.

Certain embodiments of the present invention are described above. It is, however, expressly noted that the present invention is not limited to those embodiments, but rather the intention is that additions and modifications to what is expressly described herein are also included within the scope of the invention. Moreover, it is to be understood that the features of the various embodiments described herein are not mutually exclusive and can exist in various combinations and permutations, even if such combinations or permutations are not made express herein, without departing from the spirit and scope of the invention. In fact, variations, modifications, and other implementations of what is described herein will occur to those of ordinary skill in the art without departing from the spirit and the scope of the present invention. As such, the invention is not to be defined only by the preceding illustrative description and examples.

1. A method of manufacturing an article that is at least partially porous, comprising the steps of:
placing a first layer of particles on a build plate;
subjecting the particles in at least a first portion of said first layer to a laser beam such that at least a portion of the particles in said first layer bind to each other without fully melting;
placing a second layer of particles over said first layer;
subjecting the particles in at least a first portion of said second layer to a laser beam such that at least a portion of the particles in said second layer bind to each other and to at least a portion of said first layer without fully melting; and
placing subsequent layers of particles over said second layer as necessary to form the article, and subjecting at least a portion of each subsequent layer to a laser beam such that at least a portion of the particles in each of said subsequent layers bind to each other without fully melting;
wherein the article is characterized by a thickness that exhibits a substantially homogeneous, interconnected porosity.

2. The method of claim 1, wherein the build plate is non-porous and said step of subjecting the particles in at least a portion of said first layer to a laser beam results in binding at least a portion of said first layer to the build plate; and wherein said build plate is an integral portion of the article.

3. The method of claim 1, wherein said particles in said first, second and subsequent layers comprise nickel, cobalt, iron, copper, aluminum, palladium, titanium, tungsten, platinum, silver, gold, and alloys and oxides thereof.

4. The method of claim 1, wherein said particles in said first, second and subsequent layers comprise a polymeric material.

5. The method of claim 1, wherein said particles in said first, second and subsequent layers comprise a nickel-based alloy.

6. The method of claim 1, wherein said particles in said first, second and subsequent layers comprise a stainless steel alloy.

7. The method of claim 1, wherein the particles in said first, second and subsequent layers are characterized by a shape selected from the group consisting of substantially spherical, irregular, and mixtures thereof.

8. The article of claim 1, wherein the porosity is characterized by an average pore size of 0.1 to 200 micrometers.

9. The method of claim 1, wherein the average size of said particles in said first, second and subsequent layers is within the rage of 10 to 500 micrometers.

10. The method of claim 1, further comprising the step of subjecting the particles in at least a second portion of said first layer to a laser beam having a power that is different from the power of the laser beam to which the particles in the first portion of said first layer are subjected, such that the particles in the second portion of said first layer bind to each other and form a structure having a different density than a structure formed in the first portion of said first layer.

11. The method of claim 1, further comprising the step of subjecting the particles in at least a second portion of said first layer to a laser beam that moves across the second portion of said first layer at a different rate than a rate at which the laser beam moves across the first portion of said first, such that the particles in the second portion of said first layer bind to each other and form a structure having a different density than a structure formed in the first portion of said first layer.

12. The method of claim 1, wherein the article is formed at an angle of at least 30° with respect to the build plate.

13. A method of manufacturing an article that is at least partially porous, comprising the steps of:
placing a first layer of particles on a build plate;
placing multiple subsequent layers of particles on said first layer of particles; and
subjecting the particles in at least a portion of each of said first layer and multiple subsequent layers to a laser beam before any subsequent layer of particles is placed thereon;
wherein said step of subjecting the particles in at least a portion of each of said first layer and multiple subsequent layers to a laser beam comprises
subjecting a first portion of the particles to the laser beam under first conditions that result in the formation of a first structure that is characterized by substantially homogeneous, interconnected porosity, and
subjecting a second portion of the particles to the laser beam under second conditions that result in the formation of a second structure that is substantially non-porous;
wherein the first and second structures are integrally connected to each other; and
wherein the first and second structures together form at least a portion of said article.

14. The method of claim 13, wherein the first conditions include a laser power that is less than a laser power used in the second conditions.

15. The method of claim 13, wherein the first conditions include a laser raster speed that is greater than a laser raster speed used in the second conditions.

16. The method of claim 13, wherein said particles in said first and multiple subsequent layers comprise nickel, cobalt, iron, copper, aluminum, palladium, titanium, tungsten, platinum, silver, gold, and alloys and oxides thereof.

17. The method of claim 13, wherein said particles in said first and multiple subsequent layers comprise a stainless steel alloy.

18. The method of claim 13, wherein said particles in said first and multiple subsequent layers comprise a nickel-based alloy.

19. The method of claim 16, wherein said particles in said first and multiple subsequent layers further comprise a polymeric material.

20. The method of claim 13, wherein the particles in said first and multiple subsequent layers are characterized by a shape selected from the group consisting of substantially spherical, irregular, and mixtures thereof.

21. The article of claim 13, wherein the porosity is characterized by an average pore size of 0.1 to 200 micrometers.

22. The method of claim 13, wherein the average size of said particles in said first and multiple subsequent layers is within the rage of 10 to 500 micrometers.

23. The method of claim 13, wherein the article is formed at an angle of at least 30° with respect to the build plate.

24. A method of manufacturing a hybrid assembly comprising first and second portions, comprising the steps of:
placing a first layer of particles on the first portion of said hybrid assembly;
subjecting the particles in at least a first portion of said first layer to a laser beam such that at least a portion of the particles in said first layer bind to the first portion of said hybrid assembly and to each other without fully melting;
placing a second layer of particles over said first layer;
subjecting the particles in at least a first portion of said second layer to a laser beam such that at least a portion of the particles in said second layer bind to each other and to at least a portion of said first layer without fully melting; and
placing multiple subsequent layers of particles over said second layer and subjecting at least a portion of each subsequent layer to a laser beam such that at least a portion of the particles in each of said subsequent layers bind to each other without fully melting;
wherein the first layer, second layer, and multiple subsequent layers together form the second portion of said hybrid assembly.

25. The method of claim 24, wherein at least one of the first and second portions of said hybrid assembly is characterized by a thickness that exhibits a substantially homogeneous, interconnected porosity, and other of the first and second portions of said hybrid assembly is characterized by a thickness that is substantially non-porous.

26. The method of claim 24, wherein said particles in said first, second and multiple subsequent layers comprise nickel, cobalt, iron, copper, aluminum, palladium, titanium, tungsten, platinum, silver, gold, and alloys and oxides thereof.

27. The method of claim 24, wherein said particles in said first, second and multiple subsequent layers comprise a stainless steel alloy.

28. The method of claim 24, wherein said particles in said first, second and multiple subsequent layers comprise a nickel-based alloy.

29. The method of claim 26, wherein said particles in said first, second and multiple subsequent layers further comprise a polymeric material.

30. The method of claim 24, wherein the particles in the first, second and subsequent layers are characterized by a shape selected from the group consisting of substantially spherical, irregular, and mixtures thereof.

31. The article of claim 24, wherein the porosity is characterized by an average pore size of 0.1 to 100 micrometers.

32. The method of claim 24, wherein the average size of said particles in the first, second and subsequent layers is within the rage of 10 to 500 micrometers.

33. An article that is manufactured by the method of claim 1.

34. The article of claim 33, wherein the article is a filter device.

35. The article of claim 33, wherein the article is a fluid flow restrictor device.

36. An article that is manufactured by the method of claim 13.

37. The article of claim 36, wherein the article is a filter device.

38. The article of claim 36, wherein the article is a fluid flow restrictor device.

39. A hybrid assembly that is manufactured by the method of claim 24.

40. The hybrid assembly of claim 39, wherein said hybrid assembly is a filter device.

41. The hybrid assembly of claim 39, wherein said hybrid assembly is a fluid flow restrictor device.
